(19) United States
(12) Patent Application Publication
(10) Pub. No.: US 2013/0246800 A1
(43) Pub. Date: Sep. 19, 2013

(54) Enhancing Security of Sensor Data for a System Via an Embedded Controller

(71) Applicant: MICROCHIP TECHNOLOGY INCORPORATED, Chandler, AZ (US)

(72) Inventor: Guy A. Stewart, Leander, TX (US)

(73) Assignee: Microchip Technology Incorporated, Chandler, AZ (US)

(21) Appl. No.: 13/843,530

(22) Filed: Mar. 15, 2013

Related U.S. Application Data
(60) Provisional application No. 61/612,875, filed on Mar. 19, 2012.

(51) Int. Cl. H04L 29/06

(52) U.S. Cl. CPC H04L 63/0428
USPC 713/176

(57) ABSTRACT

System and method for securing sensor data in a computer system that includes a host processor and memory that stores an operating system, and an embedded controller coupled to the host processor. The embedded processor receives sensor data for a user from at least one sensor, and encrypts and/or digitally signs the sensor data, thereby generating protected sensor data, or performs pattern recognition on the sensor data, thereby generating user identification data. The embedded processor then sends the protected sensor data or the user identification data to the operating system or another process coupled to the computer system. The protected sensor data or the user identification data are used for secure transmission of the sensor data.

### CROSS-REFERENCE TO RELATED APPLICATIONS

This application claims the benefit of U.S. Provisional Application No. 61/612,845 filed on Mar. 19, 2012, which is incorporated herein in its entirety.

### TECHNICAL FIELD

This invention relates generally to the field of device security, and more specifically to use of an embedded controller to maintain security of sensor data.

### BACKGROUND

Increasingly, computers are under threat of malicious tampering or intrusion, e.g., from unauthorized users, either locally or over networks. Identity theft, theft of secrets and similar crimes are made easier by electronic access and the portability of machines. Commensurate with this trend, there is a desire for users to maintain privacy in using their personal computers (PCs).

One trend in computer security is the increased use of user biometrics or other types of user-related data in system login or transaction procedures, where users are identified by their personal characteristics or traits, e.g., via face recognition, voice recognition, fingerprints, retinal scan, DNA sampling, personal documents, and so forth.

However, current PC architectures are not secure. For example, in current systems that rely on face recognition, the camera is connected to the south bridge of the system and the video stream from the camera (which presumably includes images of the user's face) can be intercepted and compromised by malware running inside the operating system (OS). This means that the face recognition data or pattern match results cannot be trusted. Further, the intercepted face recognition data can be viewed or made public thereby violating the privacy of the user. Other sensor based recognition systems have similar problems.

Other corresponding issues related to the prior art will become apparent to one skilled in the art after comparing such prior art with the present invention as described herein.

### SUMMARY

Various embodiments of a system and method for securing a system are presented. The system, e.g., a computer system, may include a processor and memory, and an embedded controller (EC) coupled to the processor.

According to an embodiment, a system may comprise a host processor and memory, wherein the memory stores an operating system; an embedded controller coupled to the host processor, wherein the embedded controller comprises a memory medium; a sensor unit coupled with the embedded controller to feed sensor data for a user from at least one sensor; wherein the memory medium stores program instructions executable to: receive the sensor data from the sensor unit; encrypt and/or digitally sign the sensor data, thereby generating protected sensor data; and send the protected sensor data to the operating system or another process coupled to the computer system; wherein the protected sensor data are useable for secure login by the user.

According to a further embodiment, the at least one sensor may comprise one or more of: a still camera; a video camera; a fingerprint sensor; a retinal scanner; a voiceprint sensor; or a DNA scanner. According to a further embodiment, the sensor data may comprise a data stream. According to a further embodiment, the system may further comprise at least one output device directly coupled to the embedded controller, wherein the at least one output device is configured to provide output based on the sensor data; wherein the program instructions are further executable to: receive output directly from the at least one output device; and verify origin of authentication challenges or transaction details from the operating system or the other process coupled to the computer system. According to a further embodiment, the at least one sensor may comprise a biometric sensor. According to a further embodiment, the host processor can be a central processing unit of a stationary personal computer, a mobile personal computer. According to a further embodiment, the sensor unit can be coupled with the embedded controller via a serial interface. According to a further embodiment, the system may further comprise a template memory providing secure storage for information or data. According to a further embodiment, the template memory may store sensor data for one or more authorized users of the system. According to a further embodiment, the sensor data may comprise at least one of facial image, voice print, or fingerprint data. According to a further embodiment, the template memory may store identification information for authorized users, and wherein the embedded controller is configured to compare the stored identification information to identify information provided by a smart card, or other personal identification medium.

According to another embodiment, a system may comprise a host processor and memory, wherein the memory stores an operating system; an embedded controller coupled to the host processor, wherein the embedded controller comprises a memory medium; a sensor unit coupled with the embedded controller to feed sensor data for a user from at least one sensor; wherein the memory medium stores program instructions executable to: receive the sensor data from the sensor unit; perform one or more of: encrypt and/or digitally sign the sensor data, thereby generating protected sensor data; or perform pattern recognition on the sensor data, thereby generating digitally signed user identification data; and send the protected sensor data or the digitally signed user identification data to the operating system or another process coupled to the computer system; wherein the protected sensor data or the digitally signed user identification data are useable for secure login by the user.

According to yet another embodiment, a method for secure login using a computer system that includes a host processor and memory, and an embedded controller coupled to the host processor, may comprise: receiving, by the embedded processor, sensor data for a user from at least one sensor; encrypting and/or digitally signing the sensor data, thereby generating protected sensor data, or performing pattern recognition on the sensor data, thereby generating digitally signed user identification data; and sending the protected sensor data or the digitally signed user identification data to the operating system or another process coupled to the computer system; wherein the protected sensor data or the digitally signed user identification data are useable for secure login by the user.

According to a further embodiment of the above method, the protected sensor data can be routed to the another process for one of: secure and private biometric pattern recognition, enterprise login, or financial transaction authorization. According to a further embodiment of the above method, the sensor data may comprise a data stream. According to a further embodiment of the above method, the method may further comprise: providing output by at least one output device directly coupled to the embedded controller based on the sensor data; wherein embedded processor receives the output directly from the at least one output device; and verifies an origin of authentication challenges or transaction details from the operating system or the another process. According to a further embodiment of the above method, the sensor data can be received via a serial interface. According to a further embodiment of the above method, the method may further comprise storing sensor data for one or more authorized users of the system in a template memory coupled with the embedded controller. According to a further embodiment of the above method, the sensor data may comprise at least one of facial image, voice print, or fingerprint data. According to a further embodiment of the above method, the method may further comprise storing identification information for authorized users in a template memory coupled with the embedded controller, and comparing the stored identification information by the embedded controller to identify information provided by a smart card, or other personal identification medium.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 is a high-level block diagram of an exemplary system configured to implement one embodiment of the present invention;

FIG. 2 is a more detailed block diagram of an exemplary system configured to implement one embodiment of the present invention;

FIG. 3 is a block diagram of an embedded controller with security components, according to one embodiment;

FIG. 4 is a flowchart of a method for securing sensor data, according to one embodiment; and

FIG. 5 illustrates interaction of a system with a remote server, according to one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note that the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).”

The term “include”, and derivations thereof, mean “including, but not limited to”. The term “coupled” means “directly or indirectly connected”.

### DETAILED DESCRIPTION

In one exemplary embodiment, sensor data, e.g., biometric data, such as a biometric data stream from a sensor of a security module of a computer system, such as a video stream from a camera or an audio stream from a microphone, may be routed through the embedded controller (EC), e.g., an embedded microcontroller. The EC may digitally sign and/or encrypt the sensor data to generate protected sensor data. Any encryption method may be used such as, for example, KEELOQ®. The protected sensor data may be routed to another process, e.g., an enterprise server or online financial transaction processor, for secure and private biometric pattern (user identification) recognition, enterprise login, or financial transaction authorization, among other uses. Alternatively or additionally, the EC may perform the biometric pattern recognition operation or other signal processing internally, then deliver a digitally signed user identity to the host operating system of the computer system or the other process, e.g., the enterprise server, or financial transaction server.

In a further embodiment, feedback may be provided to the EC from the entity engaged in the process. For example, in the case of image or audio based signals, display (or indicator) or speaker output may be originated by a host operating system, enterprise server, or financial transaction server (or other entity). The data may be signed and/or encrypted by the originator thereby allowing the EC to verify the origin, authenticity, and/or integrity of the data before presenting the data to the user. Said another way, in some embodiments, a speaker, a monitor (or even a light emitting diode (LED)) may be used to securely and privately relay a message or challenge from the host or server.

For example, a payment server may ask the user for a zip code to authorize a credit card transaction. This challenge may be signed and/or encrypted by the payment server. The EC may then verify the signature against the payment server's public key certificate before continuing with the payment process.

Thus, embodiments of the systems and methods described herein may provide enhanced security for a system, e.g., a computer system, by maintaining security of sensor data for secure transmission of the sensor data.

Below are described various embodiments of a system and method for securing sensor data for a system.

As used herein, a “set of instructions” may refer to one or more instructions. More specifically, in some embodiments, “instructions” may refer to programming code, software, and/or functions implemented in the form of a code that is executable by a controller, microprocessor, and/or custom logic circuit adapted to execute these instructions. In some embodiments, these instructions may comprise device drivers, control software, and/or machine code. As used herein, a “controller” refers to any type of processor, such as a central processing unit (CPU) or processor, microprocessor, or embedded microcontroller, among others.

### Overview

In one exemplary embodiment, sensor data, e.g., biometric data, such as a biometric data stream from a sensor of a security module of a computer system, such as a video stream from a camera or an audio stream from a microphone, may be routed through an embedded controller (EC), e.g., an embedded microcontroller. The EC may digitally sign and/or encrypt the sensor data to generate protected sensor data. The protected sensor data may be routed to another process, e.g., a secure process within the host operating system, an enterprise server or online financial transaction processor, for secure and private biometric pattern (user identification) recognition, enterprise login, or financial transaction authorization, among other uses. Alternatively or additionally, the EC may perform the biometric pattern recognition operation internally, then deliver a digitally signed user identity to the host operating system of the computer system or the other process, e.g., the enterprise server, or financial transaction server.

In a further embodiment, feedback may be provided to the EC from the entity engaged in the process. For example, in the case of image or audio based signals, display (or indicator) or speaker output originated by a host operating system, enterprise server, or financial transaction server (or other entity). The data may be signed and/or encrypted by the originator thereby allowing the EC to verify the origin of the data before presenting the data to the user. Said another way, in some embodiments, a speaker, a monitor (or even a light emitting diode (LED)) may be used to securely and privately relay a message or challenge from the host or server.

The following provides more detailed information regarding embodiments of the invention.

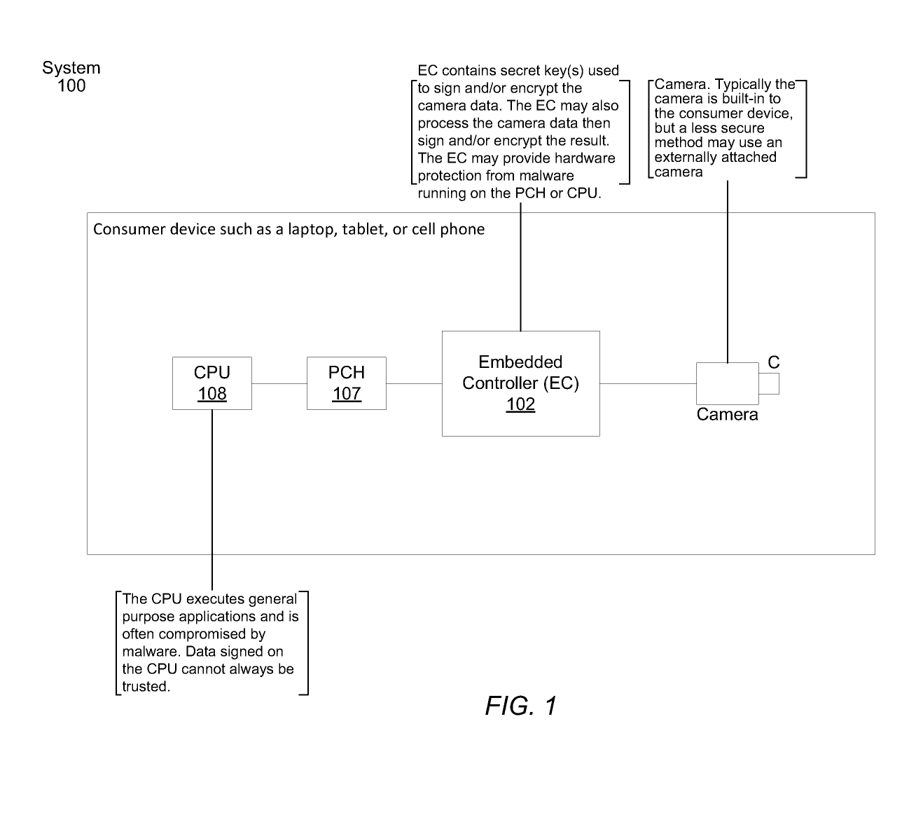

### FIG. 1—High Level Exemplary System

FIG. 1 is a high-level block diagram of an exemplary system 100 configured to implement one embodiment of the present invention. The system of FIG. 1 may be implemented in stationary personal computer or a mobile personal computer. Examples of such devices are a portable computing device, such as a handheld computer (tablet, laptop, etc.), cell phone, e.g., a smart phone, etc., or any other type of computer, as desired.

Note that the exemplary embodiment of FIG. 1 is provided to a high level understanding of some of the techniques involved, and thus, is only shown with a camera, although any other types of sensors may be used as desired. As shown, in this exemplary embodiment, the host device, e.g., a consumer device such as a laptop, tablet, or cell phone (among others), may include a CPU 108, coupled to an embedded controller (EC) 102 via a PCH (peripheral controller hub) 107, e.g., a southbridge chip. The EC is further coupled to the sensor, in this case, a camera, although any other sensors may be used as desired.

As indicated, the CPU may execute general purpose applications, which could be compromised by malware, and so data signed on the CPU 108 may not be trustworthy. Accordingly, in this embodiment, the EC may contain a secret key (or multiple such keys or “secrets”), which may be used to sign and/or encrypt the camera data (data received from the camera). In some embodiments, the EC may also process the camera data, then sign and/or encrypt the result. The EC may thus provide hardware protection from malware running on the PCH or CPU.

The camera (or more generally, the sensor) is preferably built-in to the consumer device, although in other embodiments, the camera (or sensor) may be externally attached to the device, which may not be a secure, due to possible interception/tampering external to the device.

Further embodiments are described below.

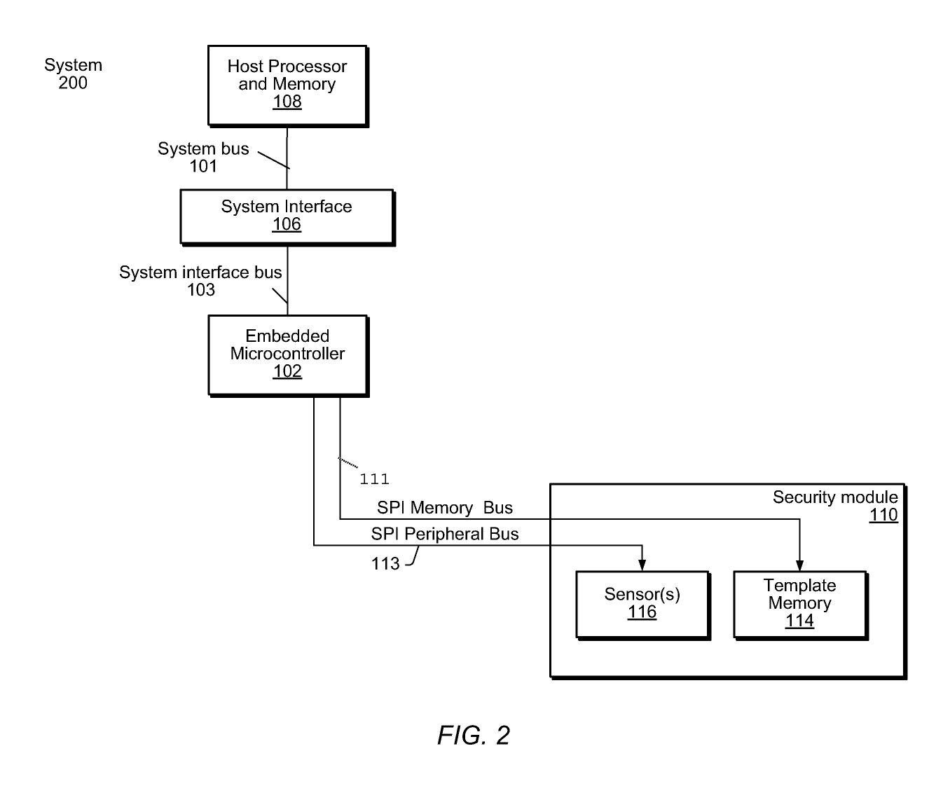

### FIG. 2—Detailed Exemplary System

FIG. 2 is a more detailed block diagram of an exemplary system 200 configured to implement one embodiment of the present invention. The system of FIG. 2 preferably resides in a computer system, e.g., a personal computer (PC), although in other embodiments, the techniques and systems described herein may be implemented in any other systems as desired.

As FIG. 2 shows, the system may include an embedded controller 102, e.g., a microcontroller, coupled to system interface 106 via a system interface bus 103, whereby the microcontroller 102 may communicate with the CPU of the computer system, referred to as the host CPU or processor, and represented as host processor and memory 108 shown in FIG. 2 coupled to the system interface via system bus 101. Note that in various embodiments, this system interface 106 may simply be a connection or bus suitable for communications between the microcontroller 102 and the host CPU 108 and thus may just be system bus 101, or may include additional structure or functionality as desired.

In other embodiments, the microcontroller 102 may be coupled to one or more additional buses that facilitate communications with a security module 110. For example, in the embodiment shown, a first bus 111, in this case, an SPI (serial peripheral interface) memory bus, coupled to a template memory 114, and a second bus 113, an SPI peripheral bus, coupled to at least one sensor 116. Note that while in the embodiment of FIG. 2, SPI buses are used to couple the sensor(s) 116 and template memory 114 to the embedded controller 102, other types of buses may be used as desired, e.g., USB, an MIPI bus, and so forth. Thus, the sensor(s) 116 may be attached directly to the EC with the EC operating as a security boundary for a cryptography or security module.

Note further that while in the embodiment of FIG. 2, the sensor(s) 116 is shown inside the security module 110, in other embodiments, one or more of the sensors may be external to the computer system. For example, in one embodiment, a camera and microphone may be located externally, but connected to the security module 110 and/or the EC.

The template memory 114 may provide secure storage for information or data related to one (or more) of the other security components, e.g., a “secret”, which may be used to authenticate a user, a transaction, or other information. For example, in one embodiment, the template memory 114 may store sensor data, e.g., facial image, voice print, or fingerprint data, among others, for one or more authorized users of the system for use with the sensor(s) 116. Additionally, or alternatively, the template memory 114 may store identification information for authorized users that may be compared to identify information provided by a smart card, or other personal identification medium.

In one embodiment, the embedded microcontroller may be configured to sign and/or encrypt sensor data, such as a facial image, from the sensor(s) 116, e.g., via hardware and firmware in the embedded microcontroller, as will be described in more detail below.

It should be noted that the particular components and buses shown in FIG. 2 are meant to be exemplary only, and are not intended to limit the scope of the present disclosure to any particular number or type of components and buses. For example, other security components contemplated include retinal scanners, fingerprint sensors, voiceprint sensors, and global positioning systems, among others. Similarly, any type of bus or transmission medium may be used as desired, including, for example, one or more of serial, parallel, wired, or wireless media, among others.

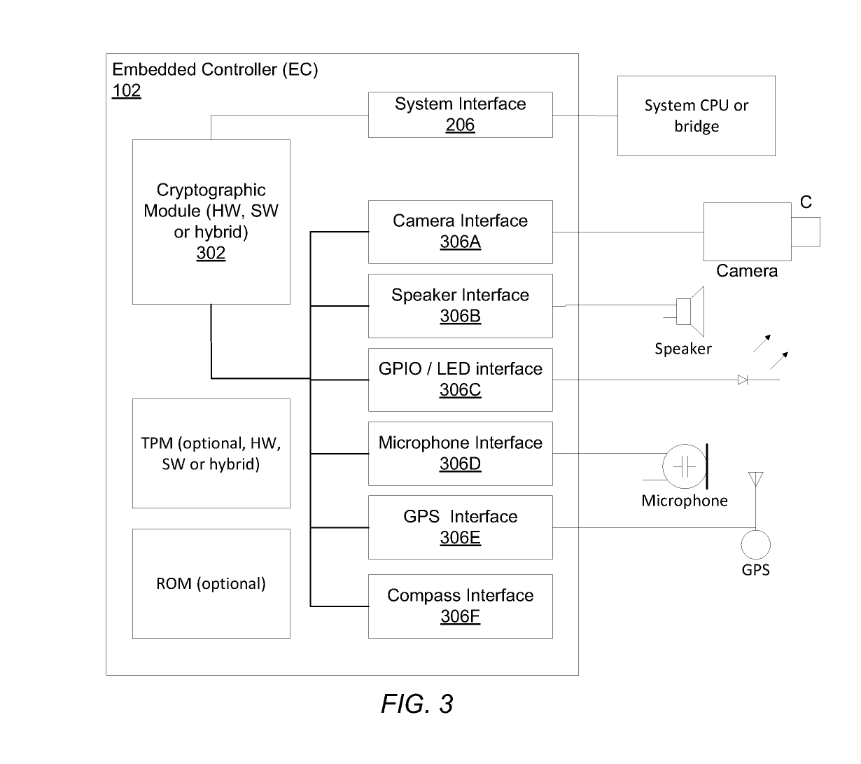

### FIG. 3—Embedded Controller

FIG. 3 is a high-level block diagram of an embedded controller, according to one embodiment. The embedded controller shown in FIG. 3 is an exemplary embedded controller suitable for use in embodiments of the systems of FIGS. 1 and 2. It should be noted that in other embodiments, other components, buses, and configurations may be used as desired.

As FIG. 3 indicates, in this embodiment, the embedded controller 102 includes a cryptographic module (or more generally, a security module) 302 coupled to various interfaces for communicating with external devices, e.g., a camera interface 306A for communicating with a camera, as shown, a speaker interface 306B for communicating with a speaker, a GPIO (general purpose I/O)/LED interface for communicating with an LED, a microphone interface 306D for communicating with a microphone, a GPS interface 306E for communicating with a GPS unit, or a compass interface 306F for communicating with compass, among other devices. In this embodiment, the interfaces include a system interface 206, corresponding to the system interface 106 of FIG. 2, for communicating with the host CPU. One or more of the sensors (and corresponding interfaces) may be used for biometric purposes, e.g., the camera, microphone, etc. Other sensors and interfaces may also be used, e.g., fingerprint sensor/interface, retinal scanner/interface, etc., as noted above. The cryptographic (or security) module 302 may be implemented via software (executing on the embedded controller), hardware, e.g., an FPGA or other programmable hardware element, or a hybrid of the two approaches.

As FIG. 3 also shows, in some embodiments, the EC 102 may also include one or more optional elements or components, e.g., a TPM (Trusted Platform Module), implemented in hardware and/or software, or a read only memory (ROM), as desired.

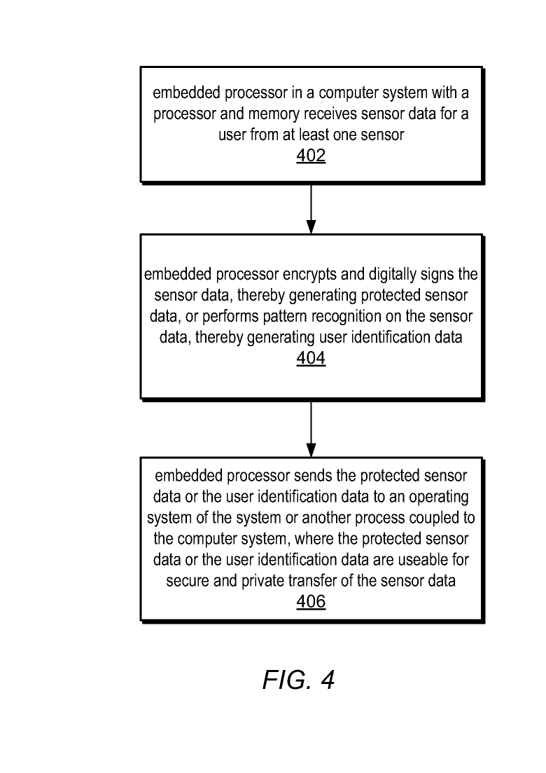

Thus, in the embodiments represented by FIGS. 1 and 2, the embedded controller may use identification-related security devices, such as sensor 116 (or others), to control access to the system (or another system or process), and may use an embedded controller to maintain security of such sensor data for secure login functionality. Further details of such security means and processes are described below with reference to FIG. 4.

### FIG. 4—Method for Verifying Security in a System

FIG. 4 is a high-level flowchart of a method for securing sensor data in a system, e.g., a computer system, comprising a host processor and memory, according to one embodiment. The method shown in FIG. 4 may be used in conjunction with any of the computer systems or devices shown in the above Figures, among others. In various embodiments, some of the method elements shown may be performed concurrently, in a different order than shown, or may be omitted. Additional method elements may also be performed as desired. As shown, this method may operate as follows.

In 402, the embedded processor may receive sensor data, e.g., for a user, from at least one sensor, such as sensor(s) 116 of FIG. 2. The sensor data may be of any type desired, and may be received from any of various types of sensor. Exemplary sensors include, but are not limited to, a still camera, a video camera, a fingerprint sensor, a retinal scanner, a voiceprint sensor, or a DNA scanner, among others. In some embodiments, the sensor data may be or include a data stream, e.g., a video stream from a video camera or an audio stream from a microphone.

In 404, the embedded controller may encrypt and/or digitally sign the sensor data, thereby generating protected sensor data, and/or may perform pattern recognition on the sensor data, thereby generating user identification data. Note that any pattern matching techniques may be used as desired, depending on the form of the sensor data, e.g., image recognition, audio recognition, etc.

In 406, the embedded controller may send the protected sensor data and/or the user identification data to the operating system or another process coupled to the computer system, e.g., over a network. The protected sensor data or the user identification data may then be useable for secure login by the user.

For example, in embodiments where the embedded controller generates protected sensor data and sends the protected sensor data to the OS or other process, the OS or other process may perform pattern recognition on the protected sensor data (e.g., after decrypting the data), and may verify/authenticate the user's identification for secure login (or conversely, may invalidate (or debunk) the asserted identity and prevent login).

Alternatively or additionally, in embodiments where the embedded processor performs the pattern matching on the sensor data and sends the resulting user identification data (which may also be encrypted and/or signed, as desired) to the OS or other process, the OS or other process may then use the authenticated or validated user identification data to complete secure login by the user, secure a transaction, etc.

### Further Embodiments

The following describes further embodiments, although it should be noted that the particular embodiments described are meant to be exemplary only, and that in various embodiments, any of the features disclosed herein may be used in any combinations desired.

As noted above, in some embodiments, feedback may be provided to the EC from the entity engaged in the process. For example, in the case of image or audio based signals, display (or indicator) or speaker output may be originated by a host operating system, enterprise server, or financial transaction server (or other entity). The data may be signed and/or encrypted by the originator thereby allowing the EC to verify the origin of the data before presenting the data to the user. Said another way, in some embodiments, a speaker, a display, e.g., a monitor or even a light emitting diode (LED), may be used to securely and privately relay a message or challenge from the host or server.

For example, a payment server may ask the user for a zip code to authorize a credit card transaction. This challenge may be signed and/or encrypted by the payment server. The EC may then verify the signature against the payment server's public key certificate before continuing with the payment process. This secure output channel may be used to communicate details of a transaction to the user, or ask the user to authorize a transaction, e.g.,: “Do you authorize a payment for $24.95?”.

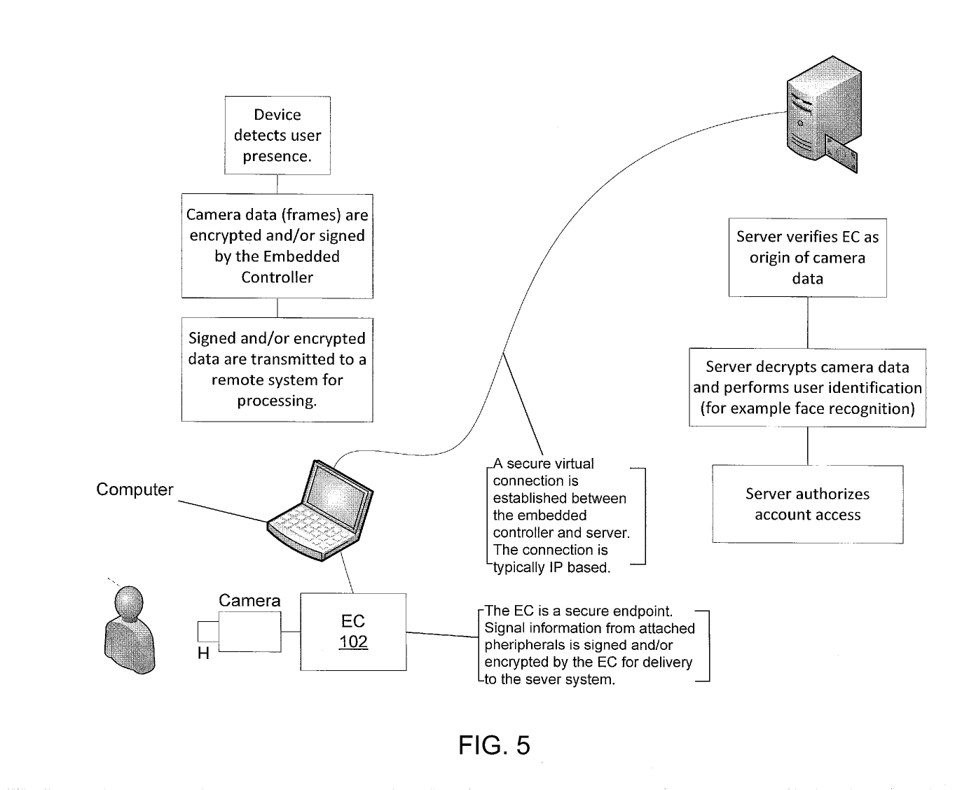

FIG. 5 illustrates an exemplary embodiment where a consumer device, such as a laptop, tablet computer, smartphone, or any other type of computing device, is coupled to a server, such as a transaction server, over a network, such as the Internet or other IP based network, which may or may not be secure (e.g., may be a neutral or hostile network).

As indicated the computer includes an embedded controller (EC) 102, which is itself coupled to a camera, which may be external or internal to the computer or consumer device. The EC may be or comprise a secure endpoint, where signal information (sensor data) from attached peripheral devices may be signed and/or encrypted by the EC for delivery to the server system. As FIG. 5 shows, in this exemplary embodiment, the device (computer) may detect a user's presence, e.g., via the camera, keyboard/mouse touch, capacitive sensor, motion detection, etc. The camera sends camera data (e.g., frames) to the EC, which may encrypt and/or sign the data (frames), and may transmit the encrypted and/or signed camera data to a remote system for processing via the network.

As also shown, upon receipt of the protected camera data (or results), the server may verify the EC as the origin of the camera data, and may decrypt (if necessary) the camera data, and/or perform user identification, e.g., via face recognition techniques. Once the user is positively identified, the server may authorize account access, approve a transaction, etc., depending on the application.

Much of the above description is focused on the use of image or voice signals from a perspective of using sensor data, e.g., biometric sensor data, challenge/response, and a stored secret (e.g., verification or authentication information), where the sensor data or signals measure “what/who you are”, the challenge/response measures “what you know”, the stored secret measures “what you have” (in this case the device with an embedded controller containing a secret key used to sign and/or encrypt the data). This approach provides multiple factors of authentication, and thus supports other aspects of measurement by the EC where direct hardware connection of the peripherals provides a secure private connection to local or cloud based applications.

For example, devices with integrated cameras may pose a threat to the user's privacy, e.g., malware executing on the host processor could operate the camera without the user's knowledge or consent. Accordingly, in one exemplary embodiment an LED attached directly to the EC may be used to securely and reliably indicate the operational status of the camera. The same or independent LEDs may also be used to indicate the operational status of other peripherals such as a microphone, GPS, compass, or accelerometer, among others.

For example, malware executing on the host processor (or any intervening or external system) could compromise or counterfeit signals from the attached peripherals. In one exemplary case, the malware might attempt to misdirect the user by supplying false GPS information to an online (cloud based) map service. The map service, using the counterfeit GPS information might direct the user to an incorrect and potentially hostile location. For example, the malware might misdirect the user simply to inconvenience them, or guide the user to a competing bar or restaurant, or even to a location where thieves are waiting to rob the user. The EC may encrypt and/or digitally sign the GPS information to prevent such tampering or counterfeiting by malware (or other agents of misfortune).

As a further example, as automotive entertainment and control systems become more sophisticated and integrated new security threats arise. Malware executing on any subsystem in a vehicle might attempt to gain control of the vehicle or falsify information about the vehicle. For example, malware might attempt to disrupt traffic by supplying false location information about the vehicle, for example, by reporting the vehicle as stalled in a high-speed lane on a major roadway. Use of a dedicated EC to digitally sign and/or encrypt the location or acceleration information may prevent this scenario from occurring.

Thus, one or more of the sensors may be used for other or additional purposes besides biometric security. In one exemplary embodiment, a camera (or other sensor, e.g., a microphone) may not only provide sensor data for the user, but may also be used to collect information (knowledge) from the user or scene. For example, a bank might ask a customer to show their bank card (hold up the bank card in front of the camera) to verify their identity, and embodiments of the system and method disclosed herein may analyze, encrypt, and/or sign the image or related results, and operate accordingly.

Thus, embodiments of the systems and methods described herein may provide enhanced system security for a system, e.g., a computer system, by routing a received sensor data stream to an embedded controller, which may digitally sign the data or a user identity (authentication) and send to another entity or process, e.g., to the host operating system of the computer system, or the another process, e.g., an enterprise server, or a financial transaction server, securely and privately, e.g., for secure login or other operations.

What is claimed is:

1. A system, comprising:
a host processor and memory, wherein the memory stores an operating system;
an embedded controller coupled to the host processor, wherein the embedded controller comprises a memory medium;
a sensor unit coupled with the embedded controller to feed sensor data for a user from at least one sensor;
wherein the memory medium stores program instructions executable to:
receive the sensor data from the sensor unit;
encrypt and/or digitally sign the sensor data, thereby generating protected sensor data; and
send the protected sensor data to the operating system or another process coupled to the computer system;
wherein the protected sensor data are useable for secure login by the user.

2. The system of claim 1, wherein the at least one sensor comprises one or more of:
a still camera;
a video camera;
a fingerprint sensor;
a retinal scanner;
a voiceprint sensor; or
a DNA scanner.

3. The system of claim 1, wherein the sensor data comprises a data stream.

4. The system of claim 1, further comprising:
at least one output device directly coupled to the embedded controller, wherein the at least one output device is configured to provide output based on the sensor data;
wherein the program instructions are further executable to:
receive output directly from the at least one output device; and
verify origin of authentication challenges or transaction details from the operating system or the other process coupled to the computer system.

5. The system of claim 1, wherein the at least one sensor comprises a biometric sensor.

6. The system of claim 1, wherein the host processor is a central processing unit of a stationary personal computer, a mobile personal computer.

7. The system of claim 1, wherein the sensor unit is coupled with the embedded controller via a serial interface.

8. The system of claim 1, further comprising a template memory providing secure storage for information or data.

9. The system of claim 8, wherein the template memory stores sensor data for one or more authorized users of the system.

10. The system of claim 9, wherein the sensor data comprise at least one of facial image, voice print, or fingerprint data.

11. The system of claim 8, wherein the template memory stores identification information for authorized users, and wherein the embedded controller is configured to compare the stored identification information to identify information provided by a smart card, or other personal identification medium.

12. A system, comprising:
a host processor and memory, wherein the memory stores an operating system;
an embedded controller coupled to the host processor, wherein the embedded controller comprises a memory medium;
a sensor unit coupled with the embedded controller to feed sensor data for a user from at least one sensor;
wherein the memory medium stores program instructions executable to:
receive the sensor data from the sensor unit;
perform one or more of:
encrypt and/or digitally sign the sensor data, thereby generating protected sensor data; or
perform pattern recognition on the sensor data, thereby generating digitally signed user identification data; and
send the protected sensor data or the digitally signed user identification data to the operating system or another process coupled to the computer system;
wherein the protected sensor data or the digitally signed user identification data are useable for secure login by the user.

13. A method for secure login using a computer system that includes a host processor and memory, and an embedded controller coupled to the host processor, the method comprising:
receiving, by the embedded processor, sensor data for a user from at least one sensor;
encrypting and/or digitally signing the sensor data, thereby generating protected sensor data, or performing pattern recognition on the sensor data, thereby generating digitally signed user identification data; and
sending the protected sensor data or the digitally signed user identification data to the operating system or another process coupled to the computer system;
wherein the protected sensor data or the digitally signed user identification data are useable for secure login by the user.

14. The method of claim 13, wherein the protected sensor data are routed to the another process for one of: secure and private biometric pattern recognition, enterprise login, or financial transaction authorization.

15. The method of claim 13, wherein the sensor data comprises a data stream.

16. The method of claim 13, further comprising:
providing output by at least one output device directly coupled to the embedded controller based on the sensor data;
wherein embedded processor receives the output directly from the at least one output device; and verifies an origin of authentication challenges or transaction details from the operating system or the another process.

17. The method of claim 13, the sensor data are received via a serial interface.

18. The method of claim 13, further comprising storing sensor data for one or more authorized users of the system in a template memory coupled with the embedded controller.

19. The method of claim 17, wherein the sensor data comprise at least one of facial image, voice print, or fingerprint data.

20. The method of claim 13, further comprising storing identification information for authorized users in a template memory coupled with the embedded controller, and comparing the stored identification information by the embedded controller to identify information provided by a smart card, or other personal identification medium.
